(19) United States
(12) Patent Application Publication
(10) Pub. No.: US 2004/0005251 A1
(43) Pub. Date: Jan. 8, 2004

(54) Allergy lamp

(76) Inventor: John David Branham, Winnsboro, SC (US)

Correspondence Address: John David Branham, 201 Sand Creek Drive, Winnsboro, SC, 29180, US

(21) Appl. No.: 10/460,870

(22) Filed: Jun. 14, 2003

Related U.S. Application Data
(60) Provisional application No. 60/390,222, filed on Jun. 20, 2002.

(51) Int. Cl. B01J 19/08; B01D 53/00

(52) U.S. Cl. 422/186.3; 204/157.3

(57) ABSTRACT

This is an apparatus that disinfects room air by destroying common allergens such as mold spore, dust mites, microbes, and VOCs, as well as dangerous substances, both organic and inorganic. Using photocatalytic oxidation, it places a continuing supply of the oxygen radical hydroxyl into a local environment. This helps prevent the spread of infectious diseases by destroying infectious microbes, contained in the droplet nuclei of human and animal respiration, as they float in the air. This apparatus also removes carbon monoxide, radon and other contaminants from the air by turning them into such harmless substances as carbon dioxide and water. It uses little energy, needs no filters, and operates silently.

### REFERENCE TO RELATED APPLICATIONS

U.S. Patent Documents

| | | | |
|---|---|---|---|
| 4892712 | January 1990 | Robertson et al. | 422/24 |
| 5032241 | July 1991 | Robertson et al. | 204/157 |
| 5045288 | September 1991 | Raupp et al. | 422/186 |
| 5835840 | November 1998 | Goswami | 422/186 |
| 5933702 | August 1999 | Goswami | 422/1 86 |
| 5993738 | November 1999 | Goswami | 422/22 |
| 6135838 | October 2000 | Wang | 445/22 |

This application claims the benefits of U.S. Provisional Application No. 60/390,222 filed Jun. 2, 2002, which is hereby incorporated by reference for all that is disclosed therein.

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

Tens of millions of Americans suffer from respiratory allergies. The respiratory symptoms of asthma, which affects approximately 15 million Americans, are often provoked by airborne allergens (substances that cause an allergic reaction). Overall, allergic diseases are among the major causes of illness and disability in the United States. Common causes of allergic reactions are mold spores, mildew, bacteria, viruses, pet dander, volatile organic compounds (VOCs), and dust mites. Inorganic compounds also pose a problem.

Airborne toxins injure many Americans each year. Carbon monoxide kills over 500 people each year and hospitalizes another 10,000. Carpets and furniture give off formaldehyde and other noxious substances.

In addition, there is growing concern about diseases that are passed in human and animal respiration.

This invention is designed to provide relief to allergy sufferers by disinfecting common allergens in room air. At the same time it reduces the transmission of air-born infectious diseases by either destroying or disinfecting microbes. It also removes toxins.

In the atmosphere photocatalytic oxidation occurs as sunlight strikes ozone creating the oxygen radical hydroxyl. This is one of the primary disinfectants of the atmosphere.

Photocatalytic oxidation has been used to treat many contaminants. It was used to decontaminate wastewater in U.S. Pat. No. 5,275,741 to Miano, et al., and waste gases in U.S. Pat. No. 6,135,838 to Wang. Prior art using photocatalytic oxidation to clean building air has focused on such problems as Legionnaires' disease or Sick Building Syndrome. These conditions are most often associated with the central heating ventilation and air conditioning (HVAC) system For instance, U.S. Pat. No. Nos. 5,835,840, 5,933,702, and 5,993,738 to Goswami are for these uses.

This Invention uses photocatalytic oxidation to clean room air without creating or using an air stream. This process involves the use of UV-A in the 320-400 nanometer wavelength, shining on a coating, applied to the interior surface of a shade, containing ZnO, TiO.sub.2, Fe.sub.2 O.sub.3, MgO, Nd.sub.2 O.sub.3, or La.sub.2 O.sub.3 as a catalyst, to produce hydroxyl radicals, which are released directly into room air. This is facilitated by the same reaction to the same coating on a screen cover, within a few inches of the UV light source. In addition, as UV photons pass through the holes in the screen mesh and strike wall and ceiling coatings that contain at least one of these catalysts, more hydroxyl radicals are placed in the air. Free floating hydroxyl radicals then destroy or disinfect allergens such as mold spores, mildew, dust mites, pet dander, microbes, VOCs and inorganic compounds they float into contact with in the air space of the living environment.

The light source is contained in a glass material that filters out most visible light and the more harmful UV rays resulting in a light source known as “black light blue”. This is safe in the direct presence of humans. According to the 1997 Recommended Practice for Photobiological Safety for Lamp and Lamp Systems: General Requirements, this type of UV light is classified as Risk Group 1 per the ANSI/IESNA RP-27.3-96 and are considered “low risk” where “the lamp does not pose any photobiological hazard due to normal behavioral limitations on exposure”. For added precaution, the invention can be placed in such away that there in no direct exposure to the light source, usually in an upward direction on a six feet tall stand.

Placing hydroxyl radicals directly in room air, where they float, is very desirable. On coming in contact with an allergen or microbe they disinfect it or render it unable to reproduce. These include mold spores, mildew, bacteria, viruses, and dust mites. On coming in contact with a volatile organic compound (VOCs) or carbon monoxide they change the substance into such harmless substances as carbon dioxide and water. Pet dander is likewise disinfected. This is important because some pet dander, especially cat dander, is so light that it can float in room air for up to ten months. Prior art does not place hydroxyl radicals into room air. There is a need for this invention.

Prior art poses a photobiological hazard and therefore must be incased within a heating duct or within a case that doesn't allow people to be exposed to its light. This is the case with U.S. Pat. No. Nos. 5,835,840, 5,933,702, and 5,993,738 to Goswami. There is a need for this invention because it poses no photobiological hazard as it eliminates allergens, infectious agents and other compounds, as they float in local environmental air. Prior art disinfects an air stream as opposed to disinfecting the air while it is in the living environment. This is the case with U.S. Pat. No. Nos. 5,835,840, 5,933,702, and 5,993,738 to Goswami. However the sources of many of these contaminants are in the living environment. To obtain relief the sources of the allergens must be decontaminated. This invention fills this need.

Some common methods of infectious disease transmission are through respiration, coughing and sneezing. These diseases are most transmittable when first released into air or have just landed on a surface. There is a need to disable the microbes as soon as possible. Prior art allows microbes, once introduced, to float in the living environment for hours, or longer. There is a need to have microbes disinfected as they are released into room air. This need is met by this invention which places hydroxyl radicals directly into room air. This invention makes them present when a contagious or allergenic element is introduced. This includes destroying infectious agents they float in droplet nuclei of human and animal respiration.

Prior art must use humidifiers, which place moisture into an air stream, to achieve the harsh environment necessary photocatalytic air disinfection of an air stream. For instance U.S. Pat. No. Nos. 5,835,840, 5,933,702, and 5,993,738 to Goswami. U.S. Pat. No. 6,135,838 to Wang also requires moisture to effective treat waste gases. Excess moisture shortens the time of existence of hydroxyl radicals since they only last about two nanoseconds when submerged in water. Moisture also encourages the multiplication of dust mites once this air reaches the living environment. For the millions of people allergic to dust mites this makes their condition worse. There is a need for cleaning the air without adding moisture. This invention fills that need.

Prior art focuses on sterilizing an air stream. It is not necessary to sterilize air in order to prevent allergic reaction and the spread of disease. Lowering the bacteria and virus count in a local environment can greatly increase the chances of not having an allergic reaction or avoiding transmission of a disease. Mold spores and bacteria that are exposed to hydroxyl and not destroyed are no longer able to reproduce, which causes their number to diminish rapidly. By operating directly in room air, this invention uses only a fraction of both energy and Uv light sources. This invention lowers air microbe count effectively.

Dust mites may live in carpets, furniture, draperies, cloths and bed covers. Since this invention places hydroxyl radicals directly into the air of living environment, they disinfect not only the contaminants in the air but the source of the contamination is disinfected as well, as they drift into contact with it. VOCs come from carpets, furniture and fabric, glues, cleaners, dyes and many household items. These are neutralized as they enter the air.

### BRIEF SUMMARY OF THE INVENTION

The primary objective of the invention is to provide relief to allergy sufferers by neutralizing allergens in room air and at their sources in the living environment.

Another objective is to prevent the spread of infectious diseases by neutralizing infectious agents released into the living environment through human and animal respiration, before it can be breathed by another human or animal.

Yet another goal is to decontaminate harmful chemicals, VOCs, carbon monoxide, radon and other toxins within the living environment.

As opposed to prior art, this invention requires no filters, collection plates nor the creation of a harsh environment. It makes no noise and only uses a fraction of the electricity of prior art. And, unlike prior art, this invention does not disturb room air, which would place allergens back in room air creating a problem for allergy sufferers.

### BRIEF DESCRIPTION OF THE DRAWING:

FIG. 1.

The invention may be further understood by the following drawing.

Meaning of the numbers and symbols in the drawing are as follows:

1. a UV light source of black light blue

2. a shade coated on the side nearest the UV light source with a photocatalyst

3. an screen cover coated with a photocatalyst

4. A switch to control the power to the UV light source

### DETAILED DESCRIPTION OF INVENTION

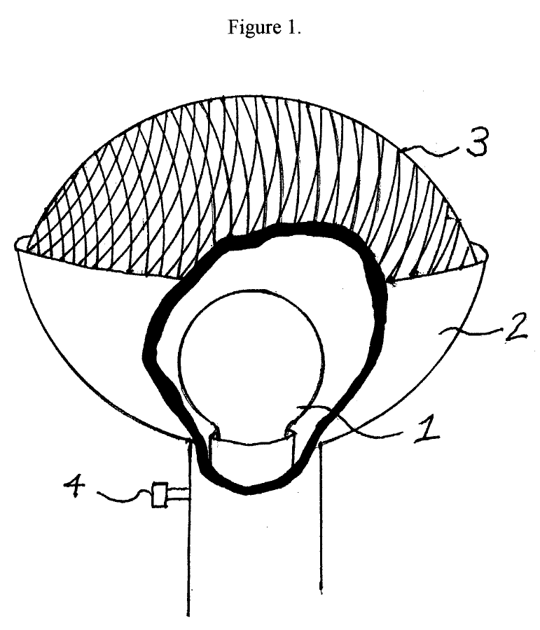

The Allergy Lamp is pictured in the drawing labeled FIG. 1. It consists of (1) an ultra violet light source of the type: black light blue, (2) a shade coated on the side nearest the light source with a coating containing ZnO, TiO.sub.2, Fe.sub.2 O.sub.3, MgO, Nd. sub.2 O.sub.3, or La. sub.2 O.sub.3, separately or in combination, (3) a screen cover coated with a coating containing ZnO, TiO.sub.2, Fe.sub.2 O.sub.3, MgO, Nd.sub.2 O.sub.3, or La.sub.2 O.sub.3, separately or in combination and (4) an off/on switch. The black light blue type light source is made of special glass that filters out most of the visible light and passes upper band UV-A. The screen cover is made of a wire mesh with a weave opening of not less than 0.01 millimeter and not greater than 10 centimeters. An airspace between the actuator screen and the black light blue UV source facilitates the spread of hydroxyl radicals into environmental air.

When photons from the ultra violet light source strike the coating on the shade and screen cover containing ZnO, TiO.sub.2, Fe. sub.2 O.sub.3, MgO, Nd. sub.2 O.sub.3, or La. sub.2 O.sub.3, it produces hydroxyl radicals which are released into the air. Zinc oxide, titanium dioxide, and iron oxide are also commonly found in wall or ceiling paints. As the photons pass from the light source, through the holes in the screen cover, they strike these surfaces producing the formation of hydroxyl radicals throughout the room. This oxidant can weaken, destroy or negatively affect the reproducing abilities of many common allergens as well as disease causing microbes. Some allergens have difficulty reproducing in the presence of ultra violent light and are affected by direct illumination. Since it is common for allergens to be found on walls, ceilings, furniture clothing, and other indoor items this invention attacks them at their source. Since the photochemical reactions also take place in the upper room air, and the resultant oxygen radicals float freely through the air, allergens and microbes suspended in droplet nuclei, produced by breathing, can be controlled before they produce infections or allergic reactions. Some people have sensitivity or allergy symptoms triggered by certain odors. These are reduced or eliminated by this invention.

Not only can the invention be used for humans, it can used in places where animals are raised to provide allergy relief and to prevent the spread of diseases.

While the invention pictured in the accompanying drawing (FIG. 1.) has a basically round design for both the shade and cover screen, almost any shape will suffice. And while the preferred direction for the Lamp to point is straight up, it can point in any direction.

The light source of the invention can be incandescent, fluorescent or any other as long as the resultant light is considered black light blue or its equivalent. The preferred wattage is 100 or less. If an area cannot be effectively covered by one Allergy Lamp the additional ones may be used.

It should be placed in a living or sleeping area and left on all on the time. With a 25 watt florescent UV light source, the invention, as designed will disinfect allergens effectively in an area of approximately twelve feet by twenty feet having a ceiling eight feet from the floor. To cover larger areas more lamps can be used, light sources with more UV energy output may be used or more screens may be added.

The preferred design is such that the allergy lamp is on a stand that is between five and six feet tall with the lamp pointing upward. The shade is best made of metal or other noncombustible material, while the screen cover is made of wire mesh. The preferred size opening in the weave of the wire mesh is between 1 and 2 millimeters. Other sizes can be used to change the effect on the room environment.

While the invention pictured in the accompanying drawing has a basically round design for both the shade and cover screen, almost any shape will suffice. And while the preferred direction for the lamp to point is straight up, it can point in any direction. It is best to place the invention in a location where the hydroxyl radicals that are produced will not be blown away, but will float in the living environment.

The light source of the invention can be incandescent, fluorescent or any other as long as the resultant light is considered black light blue or its equivalent. The preferred wattage is 100 or less. If an area cannot be effectively covered by one Allergy Lamp the additional ones may be used.

The preferable metal oxides used in the photoreactive coatings are zinc oxide or titanium dioxide or both.

For animal houses the preferred design is to hang the invention from the ceiling with both the light source and the screen pointed downward. When installed in this manner, a rectangular shape using fluorescent black light blue tubes is more desirable.

What I claim as my invention is:

1. An apparatus for disinfecting in room air by destroying allergens, dust mites, microbes, toxins, or VOC's, comprising:
an ultra violet light source;
a shade with a coating containing photoreactive material;
A screen cover with a coating containing photoreactive material;
A switch to control the light source;
Said photoreactive material is ZnO, TiO.sub.2, La.sub.2 O.sub.3, Fe. sub.2 O.sub.3, MgO, or Nd.sub.2 O.sub.3, individually or two or more of these combined.

2. The apparatus in claim 1 where the ultra violet light wavelength is between 320 and 400 nanometers.

3. The apparatus in claim 1 where the ultra violet light source is black light blue.

4. The apparatus in claim 1 where the destruction results from the creation of hydroxyl radicals.

5. The apparatus in claim 1 where the allergens are mold spores, dust mites, bacteria, pet dander, mildew or fungi.

6. The apparatus in claim 1 where the allergens are antigens.

7. The apparatus in claim 1 where the microbes are infectious disease causing microorganisms.

8. The apparatus in claim 1 where the photoreactive material is in wall coatings or ceiling coatings.

9. The apparatus in claim 1 where room is an area in a building.

10. The apparatus in claim 1 where room is an area for raising animals including poultry.

11. The apparatus in claim 1 where the screen cover is made of a wire mesh with a weave having openings between 0.01 millimeter and ten centimeters.

12. The apparatus in claim 1 where the toxins are carbon monoxide, radon or inorganic compounds.

13. The apparatus in claim 1 where the light source is pointed upward.

14. The apparatus in claim 1 where the light source is pointed downward.

15. The apparatus in claim 1 where the light source is pointed away from people and animals.

16. The apparatus in claim 1 where the apparatus is placed on a stand.

17. The apparatus in claim 16 where the stand is between five and six feet tall.

18. A method for cleaning indoor air, which does not pose a photobiological hazard where humans and animals may be present, by photocatalytically forming hydroxyl radicals directly in the indoor air by means of photons from a ultra violet light source striking a coating containing a photoreactive material.

19. In claim 18 where the ultra violet light source is black light blue.

20. In claim 18 where the photoreactive material is one or more of the following: ZnO, TiO.sub.2, La. sub.2 O.sub.3, Fe. sub.2 O.sub.3, MgO, or Nd. sub.2 O.sub.3.
